(19) United States
(12) Patent Application Publication
(10) Pub. No.: US 2014/0356812 A1
(43) Pub. Date: Dec. 4, 2014

(54) ANCHOR AND TOOTHSCREW SYSTEMS

(71) Applicant: Michelle Anderson, Otis Orchards, WA (US)

(72) Inventor: Michelle Anderson, Otis Orchards, WA (US)

(21) Appl. No.: 14/290,837

(22) Filed: May 29, 2014

Related U.S. Application Data
(60) Provisional application No. 61/828,395, filed on May 29, 2013.

(51) Int. Cl. A61C 8/00

(52) U.S. Cl. CPC A61C 8/0033; A61C 8/0051; A61C 8/0074; A61C 8/0016
USPC 433/173

(57) ABSTRACT

An anchoring receiver is implanted into a jaw bone region of a user and a novel screw and false tooth may be threadably inserted into the anchoring receiver. As the screw and false tooth member is screwed into the anchoring receiver, a biasible slit that bifurcates a bottom portion of the anchoring receiver may expand outwardly and against the jaw bone region of the user, thus providing a cost effective artificial tooth assembly having improved stability and firmness.

### CROSS-REFERENCE TO RELATED APPLICATION

The present application is related to and claims priority from prior provisional application Ser. No. 61/828,395, filed May 29, 2013 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of tooth implant devices and more specifically relates to an anchor and tooth-screw system.

2. Description of the Related Art

When a person needs one or a few teeth replaced, it can be an expensive and complicated process. The person generally has to get costly, elaborate surgery. Another common option is to use an entire set of dentures, which many find objectionable and overly burdensome.

It is commonly understood in the medical art that bone implants are useful for affixing a prosthetic piece in a bone, in replacement of any lacking natural bone or related piece. Such implants are pervasively used in dental restoration operations or surgeries but typically require multiple procedures, a prolonged healing process, and are costly. Additionally, implants such as false teeth placed into implanted or natural bone require firm and precise positioning within the bone so that the tooth implant is permanently fixed; on the other hand, the successful permanent affixing of such tooth implant results in unnatural restriction of the false tooth within the jaw or gum.

Thus, a need exists for improved implant systems and techniques overcoming at least the above mentioned challenges.

### BRIEF SUMMARY OF THE INVENTION

In view of the foregoing disadvantages, the present invention provides a novel anchor and tooth-screw system comprising an expanding anchor which can be embedded in the jawbone region of a user. Preferably, the anchor can be directly placed into a hole or cavity left by an extracted tooth. Thereafter, the screw of a false tooth assembly is screwed into the anchor, which in turn expands within a user's jaw for a snug fit. Consequently, the present invention may eliminate a need for bone replacement surgery or use of dentures to replace a single tooth.

A preferred embodiment of the present invention comprises a tooth anchoring assembly. The tooth anchoring assembly preferably includes an anchoring receiver and an artificial tooth assembly. The tooth anchoring assembly is structured and arranged to implant into a jaw bone region of a user.

The tooth anchoring assembly preferably comprises at least one anchoring receiver comprising a receiver body including a screw-receiving end, an inserting end coupled to the receiver body, and at least one gum engager. The receiver body preferably comprises plastic, more preferably FDA approved plastic for conforming to regulatory public health standards. In a preferred embodiment, such plastic may comprise polyetheretherketone which may essentially consist of a colorless organic thermoplastic polymer having high resistance to thermal degradation. The inserting end preferably comprises an outer thread located on an exterior of the inserting end. The inserting end also preferably comprises at least one biasable slit. The at least one gum engager is structured and arranged to provide friction between the receiver body of the anchoring receiver and a gum area of the user. Further, while the at least one gum engager is structured and arranged to generally inhibit the receiver body from relative movement, the gum engager still allows for slight movement, simulating the flexibility of a natural tooth.

The artificial tooth assembly preferably comprises a false tooth member coupled to a screw which is structured and arranged to support the tooth member. Preferably the false tooth member is customizable to fit within a tooth-gap space inside the mouth of the user. The false tooth member may be structured and arranged to substitute for any type of tooth, including an incisor tooth, a canine tooth, a premolar tooth, and a molar tooth.

The anchor and tooth-screw system may comprise a kit including the tooth anchoring assembly comprising at least one component selected from the anchoring receiver and the artificial tooth assembly.

A method of using an anchor and tooth-screw system may comprise the steps of: implanting an anchoring receiver into a jaw bone region of a user; and screwing a screw of an artificial tooth assembly into a screw-receiving end of the anchoring receiver thus causing an outward expansion of the biasable slit of the receiver body of the anchoring receiver.

The present invention holds significant improvements and serves as an anchor and tooth-screw system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, anchor and tooth-screw systems, constructed and operative according to the teachings of the present invention.

FIG. 1 shows a perspective view illustrating a dental procedure utilizing an anchor and tooth-screw system comprising a tooth anchoring assembly structured and arranged to implant into a jaw bone region of a user according to a preferred embodiment of the present invention.

FIG. 2A is a perspective view illustrating an anchoring receiver of the tooth anchoring assembly of FIG. 1.

FIG. 2B is a perspective view of the anchoring receiver of FIG. 2A, illustrating an interior view of the anchoring receiver.

FIG. 3A is a perspective view illustrating a false tooth assembly comprising a false tooth member structured and arranged to substitute for an incisor tooth.

FIG. 3B is a perspective view illustrating the false tooth member of the artificial tooth assembly structured and arranged to substitute for a canine tooth.

FIG. 3C is a perspective view illustrating the false tooth member of the artificial tooth assembly structured and arranged to substitute for a premolar tooth.

FIG. 3D is a perspective view illustrating the false tooth member of the artificial tooth assembly structured and arranged to substitute for a molar tooth.

FIG. 4 is a perspective view illustrating an artificial tooth implant procedure according to a preferred embodiment of the invention, wherein the artificial tooth assembly is shown being screwed into an implanted anchoring receiver. The anchoring receiver is illustrated as expanding outwardly in the jaw bone region of the user during the implant procedure.

FIG. 5 is a flowchart illustrating a method of use for the anchor and tooth-screw system according to a preferred embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a one-piece anchor and false tooth screw and more particularly to an anchor and tooth-screw system as used to improve tooth implants.

Generally speaking, anchor and tooth-screw systems may comprise a single-tooth dental implant utilizing an anchor and a screw to create a custom fit for each individual user. The anchor and tooth-screw system may comprise a false tooth comprising a built-in screw protruding from a bottom of the false tooth, and an expanding anchor. The tooth may be fabricated from a material comparable to standard dentures or false tooth implants as understood by those with familiarity in the art. The anchor is preferably constructed from a moldable material, preferably plastic, more preferably from FDA-approved plastic. The screw of the false tooth is screwed inside of the anchor, which is placed within the patient's gum. As the tooth is screwed into the anchor, the anchor preferably expands to fill the opening within the jaw (e.g. the opening left by an extracted tooth). The design may come in different shades, shapes and sizes to accommodate all teeth.

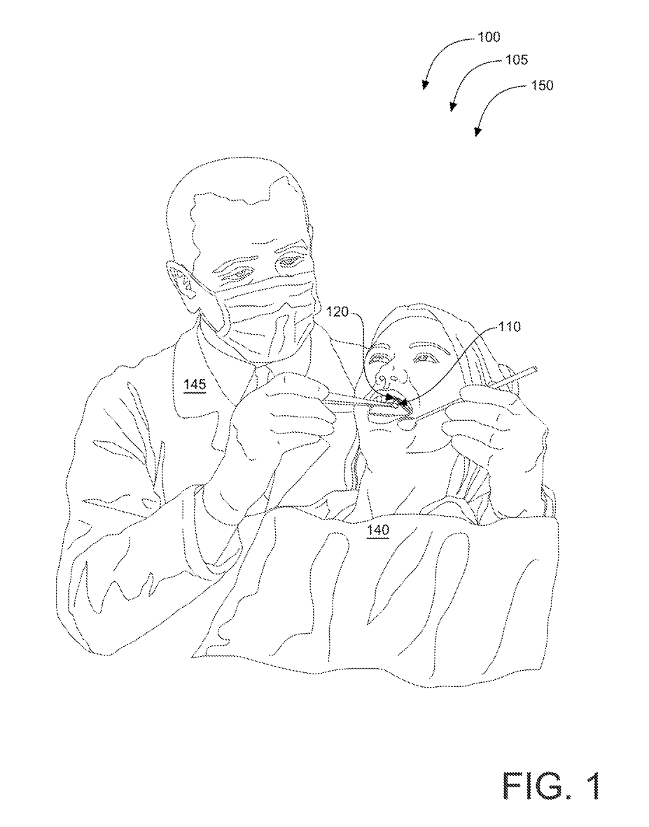

Referring to the drawings by numerals of reference there is shown in FIGS. 1-4 an anchor and tooth-screw system 100 comprising tooth anchoring assembly 105 structured and arranged to implant into a jaw bone region 410 of a user (“patient”) 140 according to a preferred embodiment of the present invention. It should be noted that anchoring assembly 105 may comprise anchor and tooth-screw system 100, and anchoring receiver 110 and artificial tooth assembly 120 may comprise in combination tooth anchoring assembly 105.

FIG. 1 illustrates a dental procedure 150 whereby a dentist 145 (“technician”) may insert artificial tooth assembly 120 into anchoring receiver 110 of tooth anchoring assembly 105 such that false tooth member 300 of artificial tooth assembly 120 is secured and anchored firmly to substitute for a tooth which may have been extracted from the mouth of user 140.

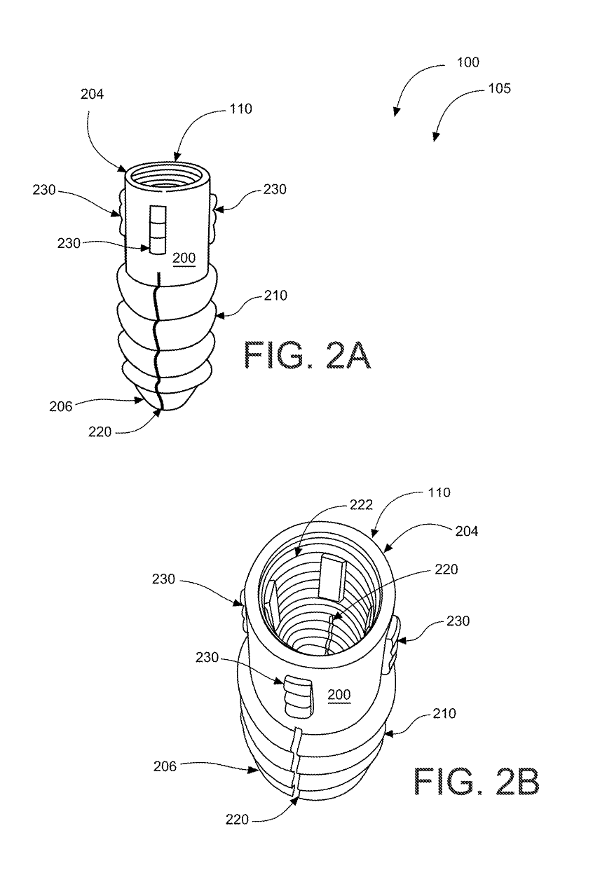

In referring to FIGS. 2A and 2B, tooth anchoring assembly 105 may generally comprise anchoring receiver 110 comprising receiver body 200 including a screw-receiving end 204, a jaw inserting end 206 (“jaw engaging portion”), and at least one gum engager 230. Inserting end 206 of anchoring receiver 110 may be structured and arranged to fixedly implant into jaw bone region 410 of user 140, preferably via outer thread 210 of anchoring receiver 110.

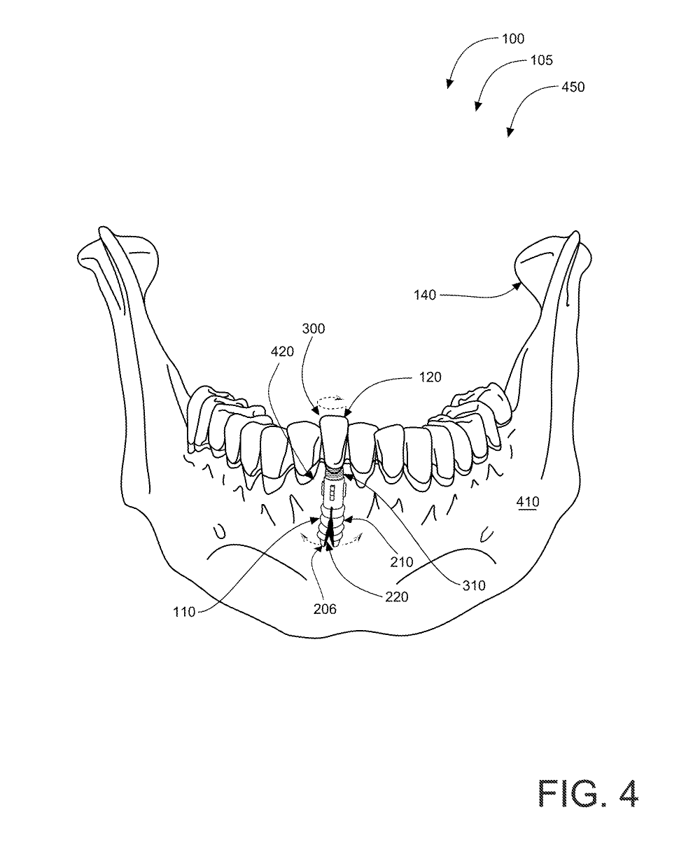

As shown in FIG. 2A, end 206 may comprise outer thread 210 located on an exterior of end 206. End 206 may further comprise a biasable slit 220. Biasable slit 220 may bifurcate at least a portion of outer thread 210 of anchoring receiver 110. Biasable slit 220 is preferably structured and arranged to cause at least a portion of end 206 to expand outwardly against jaw area 410 of user 140 when a screw 310 (“false tooth supporting member”) of artificial tooth assembly 120 is being screwed and tightened such that tooth anchoring assembly 105 is firmly implanted to maintain dental integrity, as shown best in FIG. 4.

Upon reading the teachings of this specification, those of ordinary skill in the art will now appreciate that although jaw-inserting end is illustrated concentrically threaded, under appropriate circumstances, considering such issues as design preference, user preferences, marketing preferences, cost, structural requirements, available materials, technological advances, etc., other configurations may suffice. (e.g. end 206 may be molded to conform to the cavity in the jaw, or may have spiral threads other other jagged design, etc.)

In continuing to refer to FIG. 2A, gum engager 230 may comprise at least one protrusion located about an exterior of screw-receiving end 204 of anchoring receiver 110. It should be appreciated that gum engager 230 is structured and arranged to provide friction between receiver body 200 of anchoring receiver 110 and gum area 420 of said user 140 thus restricting rotation of receiver body 200 within the jaw. To this end, gum engager 230 preferably includes a somewhat jagged design, such as the multiple crests shown in the figures. Additionally, gum engager 230 is preferably structured and arranged to allow a small degree of flexibility simulating a natural tooth. According to one preferred embodiment, receiver body 200 includes four (4) gum engagers 230 located circumferentially about an exterior of receiver body 200 of anchoring receiver 110. Upon reading the teachings of this specification, those of ordinary skill in the art will understand that, under appropriate circumstances, considering such issues as design preference, user preferences, marketing preferences, cost, structural requirements, available materials, technological advances, etc., other designs, including a different number of engagers, various shapes, and placement configurations, varying degrees of flexibility, etc. may suffice.

In referring now to FIG. 2B showing a perspective view illustrating an interior view of anchoring receiver 110 preferably comprising an inner thread 222 which is preferably spiral. As shown, inner thread 222 is located within an inner volume of screw-receiving end 204 of anchoring receiver 110. It should be appreciated that the inner thread may provide a supplemental tracking for enabling screw 310 of artificial tooth assembly 120 to be fixedly guided into anchoring receiver 110.

Preferably anchoring receiver 110 comprises a moldable material such as plastic, and more preferably FDA approved plastic for conforming to regulatory public health standards. Further, such FDA approved plastic may be biodegradable for environmentally friendly disposability.

In one embodiment of anchor and tooth-screw systems 100, the FDA approved plastic may comprise polyetherketone polymer compounds having chemical resistance properties for wear resistance from acidic-based consumables.

In another embodiment of anchor and tooth-screw systems 100, the FDA approved plastic may comprise silicone having low toxicity for minimizing toxic intake.

In yet another embodiment of anchor and tooth-screw systems 100, the FDA approved plastic may comprise polyethylenes having chemical resistance properties for wear resistance realized from gentle oxidants and reducing agents.

In still another embodiment of anchor and tooth-screw systems 100, the FDA approved plastic may comprise polyetheretherketone comprising a colorless organic thermoplastic polymer having high resistance to thermal degradation.

Upon reading the teachings of this specification, those of ordinary skill in the art will understand that, under appropriate circumstances, considering such issues as design preference, user preferences, marketing preferences, cost, structural requirements, available materials, technological advances, etc., other materials may suffice.

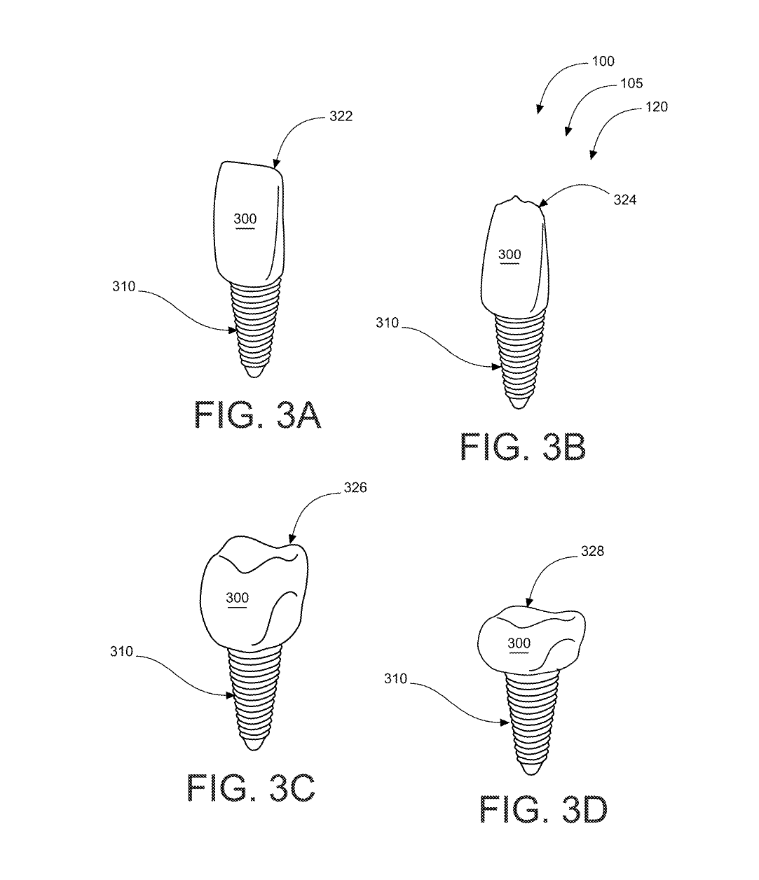

Referring now to FIGS. 3A-3D, artificial tooth assembly 120 may comprise false tooth member 300 and a false tooth support member, preferably comprising screw 310, structured and arranged to support false tooth member 300. False tooth member 300 and screw 310 may comprise in combination artificial tooth assembly 120. As shown, screw 310 may be integrally mounted to a bottom portion of false tooth member 300. Screw 310 may be structured and arranged to threadably-insert into screw-receiving end 204 of anchoring receiver 110. It should be noted that false tooth member 300 may comprise a variety of shades, tints, colors, shapes, sizes, profiles, and sharpness or dullness, and may be custom molded to match the patient's natural tooth. Such tooth may be molded according to any currently known method, or method(s) which may be developed in the future. Additionally, a premade custom or generically sized tooth may be further shaped (e.g. chiseled) according to any known current of future method, according to the needs of the particular patient.

Referring now to FIG. 3A illustrating false tooth member 300 of artificial tooth assembly 120 structured and arranged to substitute for incisor tooth 322 according to an embodiment of the present invention of FIG. 1. As shown, tooth member 300 may comprise an appearance and profile to substitute for incisor tooth 322 located in the premaxilla above and on the mandible below.

Referring now to FIG. 3B illustrating false tooth member 300 of artificial tooth assembly 120 structured and arranged to substitute for canine tooth 324 according to an embodiment of the present invention of FIG. 1. As shown, false tooth member 300 may comprise an appearance and profile to substitute for canine tooth 324 located in the maxillary bone.

Referring now to FIG. 3C illustrating false tooth member 300 of artificial tooth assembly 120 structured and arranged to substitute for premolar tooth 326 according to an embodiment of the present invention of FIG. 1. As shown, false tooth member 300 may comprise an appearance and profile to substitute for premolar tooth 326 located between the canine and molar teeth.

Referring now to FIG. 3D illustrating false tooth member 300 of artificial tooth assembly 120 structured and arranged to substitute for molar tooth 328 according to an embodiment of the present invention of FIG. 1. As shown, false tooth member 300 may comprise an appearance and profile to substitute for molar tooth 328 generally located toward the back of the mouth.

Upon reading the teachings of this specification, those of ordinary skill in the art will understand that, under appropriate circumstances, considering such issues as design preference, user preferences, marketing preferences, cost, structural requirements, available materials, technological advances, etc., the system may be used to implant more than a single tooth. Additionally, procedures implanting a plurality of false teeth, using less anchoring receivers than the number of teeth implanted, (i.e. a bridge) is within the scope of the invention.

Referring now to FIG. 4, showing biasable slit 220 of anchoring receiver 110 expanding outwardly in jaw bone region 410 of user 140 during ‘in-use’ condition 450 according to an embodiment of the present invention. As shown, when artificial tooth assembly 120 is inserted into anchoring receiver 110 and securely screwed in place, screw 310 preferably causes biasable slit 220 to open causing end 206 to push outwardly against jaw bone region 410 of user 140 such that biasable slit 220 of receiver body 200 acts as an anchor and firmly implants artificial tooth assembly 120 in place. In such a manner, biasable slit 220 affixes anchoring receiver 110 and provides stability to false tooth member 300.

It should be appreciated that at least one dimension of false tooth member 300 is customizable to fit within a tooth-gap space inside a mouth of user 140. In such a manner, false tooth member 300 may be adjustably shaped to fit varying tooth-gap spaces.

In a preferred method of constructing and preparing anchor and tooth-screw systems 100, false tooth member 300 and anchor are preferably customized to specifically fit the user. According to one preferred embodiment, each component is producible via at least one 3D printer. The 3D printer preferably prints plastics as described herein that are FDA approved. Other methods of custom product, including methods which become available with emerging technology will be apparent to one skilled in the art and are within the scope of the present invention.

Anchor and tooth-screw systems 100 may be sold as a kit comprising at least one, and preferably all of the following parts: tooth anchoring assembly 105 comprising anchoring receiver 110 and artificial tooth assembly 120; and at least one set of user instructions. The kit may include instructions such that functional relationships are detailed in relation to the structure of the invention (such that the invention can be used, maintained, or the like in a preferred manner). Anchor and tooth-screw systems 100 and/or individual components of the system, may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

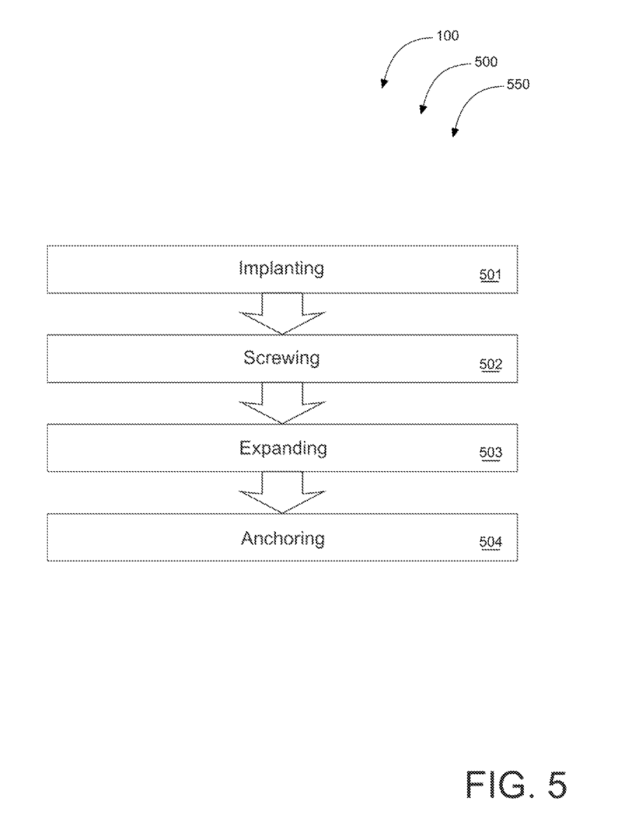

Referring now to FIG. 5 showing flowchart 550 illustrating method of use 500 for anchor and tooth-screw system 100 according to an embodiment of the present invention of FIGS. 1-4. As shown, method of use 500 may comprise the steps of: step one 501, implanting anchoring receiver 110 into jaw bone region 410 of user 140; step two 502, screwing screw 310 of artificial tooth assembly 120 into screw-receiving end 204 of anchoring receiver 110; step three 503, expanding outwardly biasable slit 220 of receiver body 200 of anchoring receiver 110; and step four 504, anchoring false tooth member 300 of artificial tooth assembly 120 into gum area 420 of user 140. Step one 501 of implanting may be carried out after removing a tooth. Thus, receiver 110 may be implanted in the hole or cavity left pursuant to the extraction. According to one embodiment, receiver 110 may simply be placed in the cavity site. Alternatively, filler material may be utilized depending on the particular need of the patient and/or technician preference. Also alternatively, the cavity site may be prepared (e.g. by drilling, chiseling etc.) as required to accommodate implanting based on specific needs of the patient, size of receiver, technician preference, etc.

Additionally, according to the above method, any component of the system may be generically prefabricated, customized, adjusted, and/or shaped, etc.

It should be noted that the steps described in the method of use can be carried out in many different orders according to user preference. The use of “step of should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An anchor and tooth-screw system comprising:
a tooth anchoring assembly structured and arranged to implant into a jaw bone region of a user, said tooth anchoring assembly comprising:
a) at least one anchoring receiver comprising:
1) a receiver body including a screw-receiving end;
2) an inserting end coupled to said receiver body, said inserting end comprising an outer thread located on an exterior of said inserting end, said inserting end further comprising at least one biasable slit; and
3) at least one gum engager;
b) at least one artificial tooth assembly comprising:
a) at least one false tooth member; and
b) at least one screw structured and arranged to support said at least one false tooth member;
wherein said tooth anchoring assembly comprises said anchor and tooth-screw system;
wherein said at least one anchoring receiver and said at least one artificial tooth assembly comprises in combination said tooth anchoring assembly;
wherein said at least one biasable slit bifurcates at least a portion of said outer thread of said at least one anchoring receiver;
wherein said at least one gum engager comprises at least one protrusion located about an exterior of said screw-receiving end of said at least one anchoring receiver;
wherein said at least one false tooth member and said at least one screw comprises in combination said at least one artificial tooth assembly;
wherein said at least one screw is integrally mounted to a bottom portion of said false tooth member;
wherein said at least one screw is structured and arranged to threadably-insert into said screw-receiving end of said at least one anchoring receiver;
wherein said inserting end of said at least one anchoring receiver is structured and arranged to fixedly implant into said jaw bone region of said user via said outer thread of said at least one anchoring receiver; and
wherein said at least one biasable slit is structured and arranged to expand outwardly against a gum area of said user when said at least one screw of said at least one artificial tooth assembly is being screwed and tightened such that said tooth anchoring assembly is firmly implanted to maintain dental integrity.

2. The anchor and tooth-screw system of claim 1 wherein said at least one gum engager is structured and arranged to provide friction between said receiver body of said at least one anchoring receiver and said gum area of said user.

3. The anchor and tooth-screw system of claim 2 wherein said at least one gum engager is structured and arranged to generally inhibit movement of said receiver body with respect to said gum area.

4. The anchor and tooth-screw system of claim 3 wherein said at least one anchoring receiver comprises plastic.

5. The anchor and tooth-screw system of claim 4 wherein said plastic is environmentally friendly.

6. The anchor and tooth-screw system of claim 4 wherein said plastic comprises polyetherketone polymer compounds having chemical resistance properties for wear resistance from acidic-based consumables.

7. The anchor and tooth-screw system of claim 4 wherein said plastic comprises silicone having low toxicity for minimizing toxic intake.

8. The anchor and tooth-screw system of claim 4 wherein said plastic comprises polyethylenes having chemical resistance properties for wear resistance realized from gentle oxidants and reducing agents.

9. The anchor and tooth-screw system of claim 1 wherein said plastic comprises polyetheretherketone comprising a colorless organic thermoplastic polymer having high resistance to thermal degradation.

10. The anchor and tooth-screw system of claim 4 wherein said false tooth member is structured and arranged to substitute for at least one of an incisor tooth, a canine tooth, a premolar tooth, and a molar tooth.

11. The anchor and tooth-screw system of claim 4 wherein at least one dimension of said false tooth member is customizable to fit within a tooth-gap space inside a mouth of said user.

12. The anchor and tooth-screw system of claim 4 wherein said false tooth member is producible via at least one 3D printer.

13. The anchor and tooth-screw system of claim 4 wherein said at least one anchoring receiver comprises an inner thread, said inner thread located within an inner volume of said screw-receiving end of said at least one anchoring receiver.

14. The anchor and tooth-screw system of claim 13 wherein said inner thread, said inner thread provides a tracking for allowing said at least one screw of said artificial tooth assembly to be fixedly guided into said at least one anchoring receiver.

15. An anchor and tooth-screw system comprising:
a tooth anchoring assembly, comprising an anchoring receiver structured and arranged to implant into a jaw bone region of a user, and to anchor at least one false tooth member of an artificial tooth assembly into said jaw bone region, said anchoring receiver comprising:
1) a receiver body including a screw-receiving end;
2) an inserting end coupled to said receiver body, said inserting end comprising an outer thread located on an exterior of said inserting end, said inserting end further comprising at least one biasable slit; and
3) at least one gum engager, said at least one gum engager structured and arranged to provide friction between said receiver body of said at least one anchoring receiver and said gum area of said user, said at least one gum engager structured and arranged restrict movement of said receiver bod, wherein
said artificial tooth assembly comprises at least one false tooth support member comprising a screw, coupled to said at least one false tooth, said screw structured and arranged to threadably insert into said screw receiver end of said receiver body, wherein said at least one biasable slit bifurcates at least a portion of said outer thread of said at least one anchoring receiver;
said at least one gum engager comprises at least one protrusion located about an exterior of said screw-receiving end of said at least one anchoring receiver;
said inserting end of said at least one anchoring receiver is structured and arranged to fixedly implant into said jaw bone region of said user via said outer thread of said at least one anchoring receiver; and wherein
said at least one biasable slit is structured and arranged to expand outwardly against a gum area of said user when said at least one screw of said at least one artificial tooth assembly is being screwed and tightened such that said tooth anchoring assembly is firmly implanted to maintain dental integrity

16. The system of claim 15, said anchoring receiver comprising polyetheretherketone comprising a colorless organic thermoplastic polymer having high resistance to thermal degradation.

17. A method of using an anchor and tooth-screw system comprising the steps of:
implanting at least one anchoring receiver into at least one jaw bone region of a user, said at least one anchoring receiver structured and arranged to receive a tooth support member of a false tooth assembly;
inserting a tooth support member of a false tooth assembly into said at least one anchoring receiver,
said tooth support member comprising at least one false tooth supported on said at least one tooth support member,
said at least one anchoring receiver comprising a jaw engaging portion structured and arranged to expand upon insertion of said tooth support member;
expanding said jaw engaging portion against said at least one jaw region; and
anchoring said at least one false tooth member of said artificial tooth assembly into a gum area of said user.

18. The method of claim 17, said jaw engaging portion of said anchoring receiver comprising at least one outwardly a biasable slit structured and arranged to cause said jaw engaging portion to expand upon insertion of said false tooth support member.

19. The method of claim 17, said tooth support member comprising a screw, said anchoring receiver comprising a screw receiving end opposite said jaw engaging portion, wherein said tooth support member is inserted by screwing said screw into said screw receiving end of said anchoring receiver.

20. The method of claim 17, wherein said anchoring receiver is implanted into a hole in said at least one jaw bone region, said hole resulting from extraction of at least one tooth from said at least one jaw bone region.
